(19) United States
(12) Patent Application Publication
(10) Pub. No.: US 2023/0002099 A1
(43) Pub. Date: Jan. 5, 2023

(54) PACKAGE OPENING SYSTEM

(71) Applicants: KYOTO SEISAKUSHO CO., LTD., Kyoto-shi, Kyoto (JP); CHUGAI SEIYAKU KABUSHIKI KAISHA, Tokyo (JP)

(72) Inventors: Hiroaki HIGASHI, Kyoto-shi, Kyoto (JP); Yuta IMAI, Kyoto-shi, Kyoto (JP); Yasuzumi MINEO, Kyoto-shi, Kyoto (JP); Hideaki HOSAKA, Tokyo (JP)

(21) Appl. No.: 17/756,756

(22) PCT Filed: Dec. 3, 2020
(86) PCT No.: PCT/JP2020/045097

§ 371 Date: Jun. 1, 2022

(30) Foreign Application Priority Data
Dec. 11, 2019 (JP) 2019-223879

(51) Int. Cl. B65B 69/00

(52) U.S. Cl. CPC B65B 69/0033

(57) ABSTRACT

A package opening system for opening a package in which an outer peripheral edge of a sheet-like lid is bonded to a flange-shaped opening edge of a tub storing a stored object includes: a cutter blade capable of cutting the lid; and a cutter blade moving device configured to stick the cutter blade into the lid and move the cutter blade stuck into the lid in a cutting path along at least part of a contour of an opening of the tub.

### TECHNICAL FIELD

The present disclosure relates to a package opening system for opening a package.

### BACKGROUND ART

A package that hermetically stores a plurality of drug containers such as syringes and vials at regular intervals by using a nest has been conventionally used. Such a package is formed by bonding an outer peripheral edge of a sheet-like lid to a flange-shaped opening edge of a tub storing the plurality of drug containers and the nest with an adhesive.

An apparatus for opening a package including a tub and a lid as described above is disclosed in Patent Document 1. The apparatus peels off the lid from the tub by moving the tub while gripping an end of the lid by using a clamp.

### PRIOR ART DOCUMENTS

### Patent Documents

Patent Document 1: JP 2019-521813 A

### SUMMARY OF THE INVENTION

### Problems to be Solved by the Invention

However, in the apparatus disclosed in Patent Document 1, the clamp may fail to grip the end of the lid. Further, the adhesive bonding the tub and the lid may fall off the lid or the tub when the lid is peeled off from the tub, which may cause contamination by the adhesive.

In view of this, an object of the present disclosure is to open a package in which an outer peripheral edge of a lid is bonded to an opening edge of a tub while preventing contamination by an adhesive.

### Means for Solving the Problems

In order to solve the above technical problem, one aspect of the present disclosure provides

a package opening system for opening a package in which an outer peripheral edge of a sheet-like lid is bonded to a flange-shaped opening edge of a tub storing a stored object, the package opening system including:

a cutter blade capable of cutting the lid; and

a cutter blade moving device configured to stick the cutter blade into the lid and moves the cutter blade stuck into the lid in a cutting path along at least part of a contour of an opening of the tub.

### Effects of the Invention

According to the present disclosure, it is possible to open a package in which an outer peripheral edge of a lid is bonded to an opening edge of a tub while preventing contamination by an adhesive.

### BRIEF DESCRIPTION OF THE DRAWINGS

FIG. 1 is a perspective view of an example of a package that is opened by a package opening system according to an embodiment of the present disclosure.

FIG. 2 is an exploded perspective view of a package.

FIG. 3 is a schematic top view of a package opening system.

FIG. 4 is a block diagram illustrating a configuration of a package opening system.

FIG. 5A is a schematic top view of a package opening system, which illustrates a package passing through a measurement position.

FIG. 5B is a schematic side view of a package opening system, which illustrates a package passing through a measurement position.

FIG. 6A is a schematic top view of a package opening system, which illustrates a package clamped by a clamping device.

FIG. 6B is a schematic side view of a package opening system, which illustrates a package clamped by a clamping device.

FIG. 7A is a schematic top view of a package opening system, which illustrates a package being opened by a cutter blade.

FIG. 7B is a schematic side view of a package opening system, which illustrates a package being opened by a cutter blade.

FIG. 8 is a schematic side view of a package opening system, which illustrates a lid collection device that holds a portion of a lid separated from a tub.

FIG. 9 is a schematic top view of a package opening system in a state in which a portion of a lid separated from a tub is carried to a disposal position.

FIG. 10 is a side view of a suction table.

FIG. 11 is an explanatory diagram of a method of calculating a shape of an opening of a tub on the basis of distances measured by first and second distance measuring sensors.

### MODE(S) FOR CARRYING OUT THE INVENTION

A package opening system according to an aspect of the present disclosure is a package opening system for opening a package in which an outer peripheral edge of a sheet-like lid is bonded to a flange-shaped opening edge of a tub storing a stored object, the package opening system including: a cutter blade capable of cutting the lid; and a cutter blade moving device configured to stick the cutter blade into the lid and moves the cutter blade stuck into the lid in a cutting path along at least part of a contour of an opening of the tub.

According to the aspect, it is possible to open the package in which the outer peripheral edge of the lid is bonded to the opening edge of the tub while preventing contamination by an adhesive.

For example, the cutter blade moving device may be an articulated robot including the cutter blade as an end effector.

For example, in a case where the cutter blade moving device moves the cutter blade in an annular cutting path along an entire contour of the opening of the tub, the package opening system may further include a lid holding device configured to hold a portion of the lid surrounded by the annular cutting path during the cutting of the lid by the cutter blade.

For example, the package opening system may further include a disposal device for the lid. In that case, the lid holding device may carry the portion of the lid toward the disposal device when the held portion of the lid is separated from the tub.

For example, the package opening system may further include: a tub opening shape calculation unit configured to acquire a shape of a side wall of the tub defining the opening and calculate a shape of the opening on the basis of the shape of the side wall; and a cutting path calculation unit configured to calculate the cutting path on the basis of the shape of the opening calculated by the tub opening shape calculation unit.

For example, the package opening system may further include: a conveying device configured to carry the package to an opening position where the lid is cut and opened by the cutter blade; and first and second distance measuring sensors arranged on both sides of a measurement position through which the package being moved by the conveying device toward the opening position passes and configured to continuously measure a distance from the side wall until the package completely passes through the measurement position. In this case, the tub opening shape calculation unit may calculate the shape of the side wall on the basis of a change in distance measured by each of the first and second distance measuring sensors.

For example, the conveying device may be a belt conveyor. In this case, the package opening system may further include a clamping device configured to clamp and fix the tub of the package on the belt conveyor at the opening position.

For example, the stored object may include a plurality of drug containers.

Hereinafter, an embodiment of the present disclosure will be described with reference to the drawings.

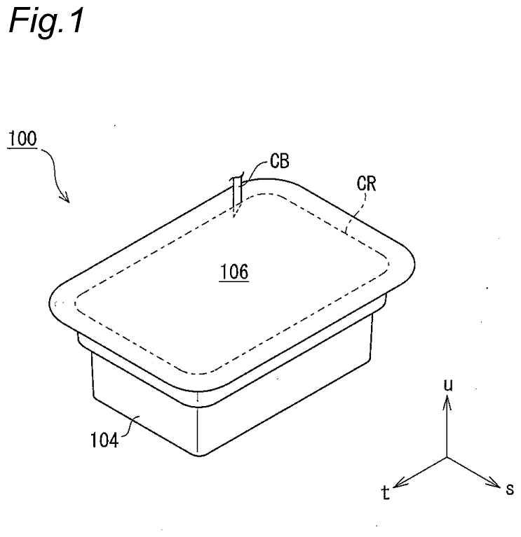

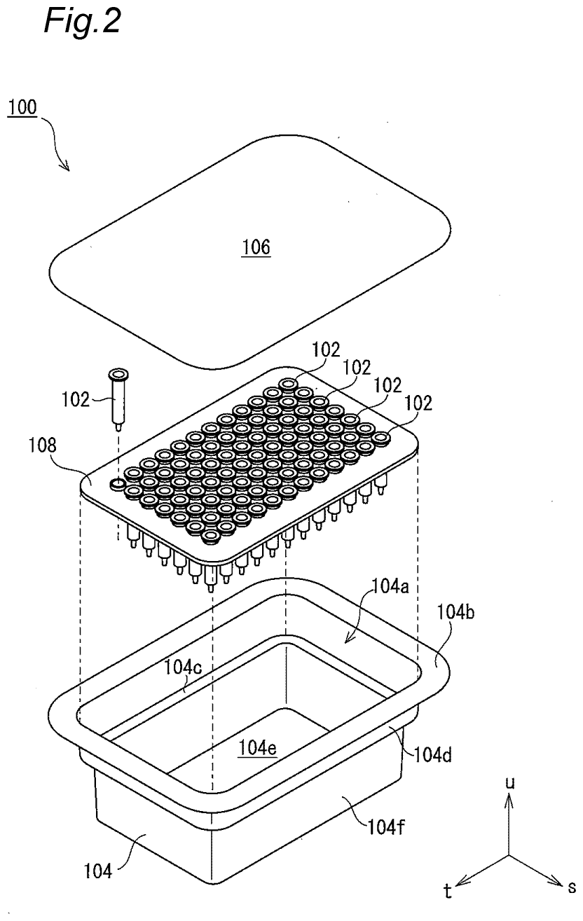

FIG. 1 is a perspective view of an example of a package that is opened by a package opening system according to an embodiment of the present disclosure. FIG. 2 is an exploded perspective view of the package. In FIGS. 1 and 2, an s-t-u orthogonal coordinate system is used to easily understand the present disclosure, but does not limit the embodiment of the present disclosure. An s-axis direction represents a width direction of the package, a t-axis direction represents a length direction of the package, and a u-axis direction represents a height direction.

First, an example of a package that is opened by the package opening system according to the embodiment of the present disclosure will be described with reference to FIGS. 1 and 2.

As illustrated in FIGS. 1 and 2, a package 100 is a sealed container for hermetically storing a plurality of drug containers 102 to be filled with a drug or the like, for example, the drug containers 102 such as syringes or vials until the drug containers start being filled with the drug.

Specifically, the package 100 includes a tub 104 that stores the plurality of drug containers 102 as a stored object and has an opening 104a for taking out the drug containers 102 and a lid 106 that covers the opening 104a of the tub 104. The package 100 also includes a plate-like nest 108 that holds the plurality of drug containers 102 at regular intervals.

The tub 104 is made from, for example, a resin material and has a flange-shaped opening edge 104b. The tub 104 also has a shoulder 104c on which an outer peripheral edge of the nest 108 is placed. The shoulder 104c is formed between a first side wall 104d defining the opening 104a and extending from the opening edge 104b and a second side wall 104f extending from a bottom 104e. In the present embodiment, the opening 104a, the opening edge 104b, the first side wall 104d, and the second side wall 104f have a rectangular shape with rounded corners, as viewed in the height direction (u-axis direction) of the package 100.

The lid 106 is, for example, a sheet-like lid body made from a resin material. Specifically, an outer peripheral edge of the lid 106 is bonded to the opening edge 104b of the tub 104 via an adhesive, whereby the lid 106 covers the opening 104a of the tub 104.

The lid 106 is bonded to the opening edge 104b of the tub 104 so as to be peelable therefrom. The package 100 is opened by peeling off the lid 106 from the tub 104. However, the package opening system according to the embodiment of the present disclosure opens the package 100 without peeling off the lid 106.

Specifically, as illustrated in FIG. 1, the package opening system according to the present embodiment cuts and opens the package 100 by moving a cutter blade CB stuck into the lid 106 in an annular cutting path CR along the entire contour of the opening 104a of the tub 104.

The package opening system according to the present embodiment can also open the packages 100 having different sizes or the packages 100 having, in spite of the same size in design, a dimensional difference between individuals due to a variation factor or the like in manufacturing.

Hereinafter, details of the package opening system according to the present embodiment will be described.

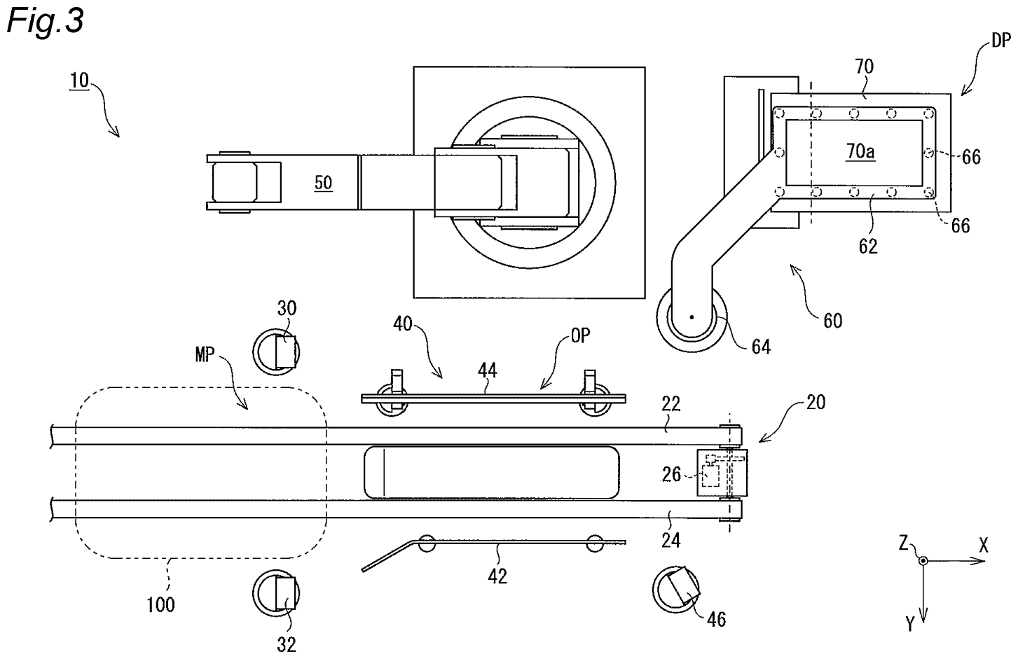

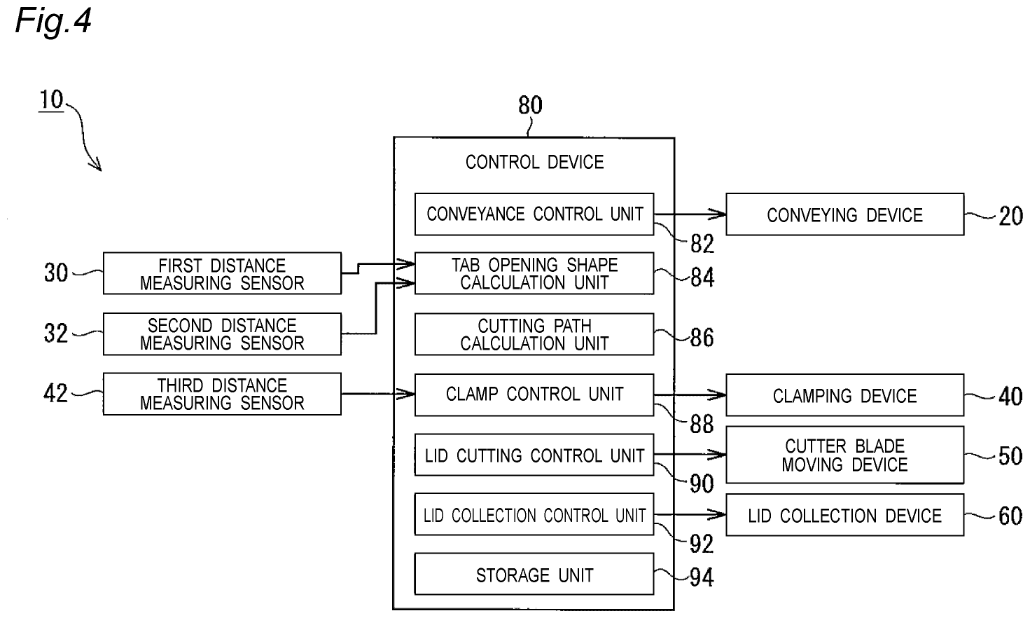

FIG. 3 is a schematic top view of the package opening system. FIG. 4 is a block diagram illustrating a configuration of the package opening system. In FIGS. 3 and 4, an X-Y-Z orthogonal coordinate system is used to easily understand the present disclosure, but does not limit the embodiment of the present disclosure. An X-axis direction and a Y-axis direction represent a horizontal direction, and a Z-axis direction represents a vertical direction.

As illustrated in FIGS. 3 and 4, first, a package opening system 10 according to the present embodiment includes a conveying device 20 that carries the package 100 to a position (opening position) OP where the lid 106 is cut and opened by the cutter blade CB.

In the present embodiment, the conveying device 20 is a belt conveyor. Specifically, the conveying device 20 includes two endless conveyor belts 22 and 24 and a servomotor 26 that synchronously drives the two conveyor belts 22 and 24. The two conveyor belts 22 and 24 are arranged in parallel with a gap therebetween. The package 100 is placed on the two conveyor belts 22 and 24, and, in this state, the servomotor 26 drives the conveyor belts 22 and 24, thereby carrying the package 100 toward the opening position OP.

In the present embodiment, the package opening system 10 calculates a shape of the opening of the tub 104 of the package 100 in order to cope with the packages 100 having different sizes or having a dimensional difference between individuals in spite of the same size in design. In order to calculate the shape of the opening, the package opening system 10 includes a first distance measuring sensor 30 and a second distance measuring sensor 32.

Specifically, a measurement position MP is set upstream from the opening position OP in a conveying direction (X-axis direction) of the package 100. The first and second distance measuring sensors 30 and 32 are arranged on both sides of the package 100 at the measurement position MP.

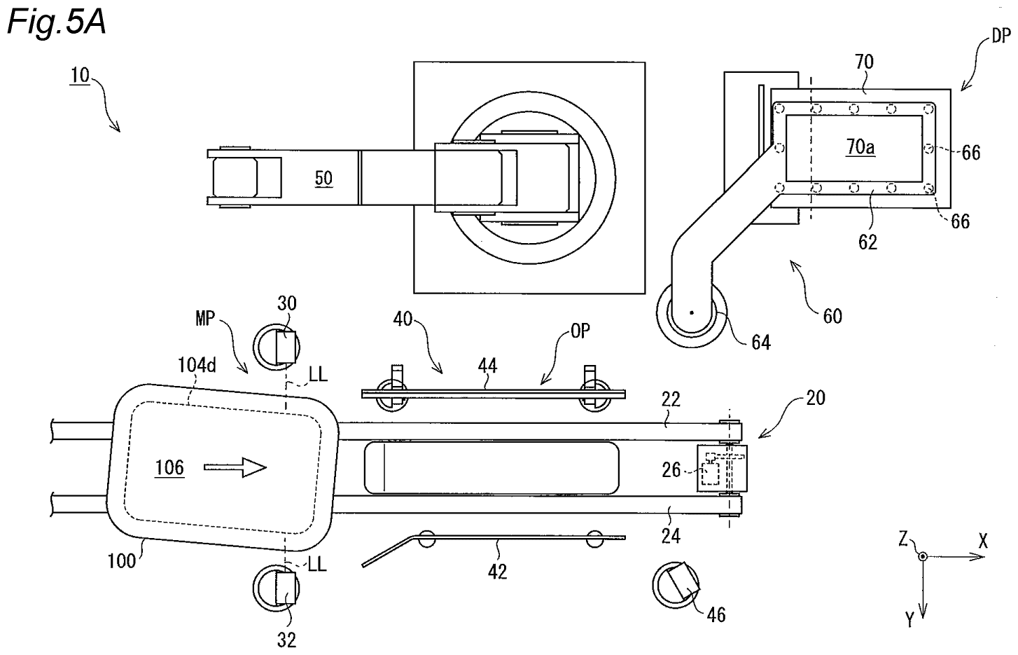

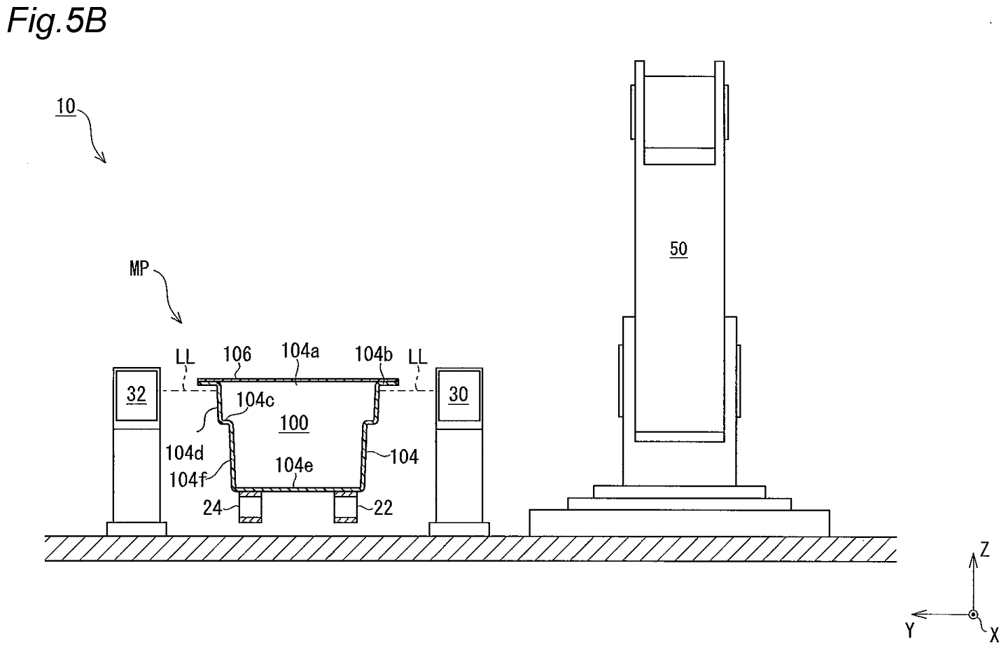

FIG. 5A is a schematic top view of the package opening system, which illustrates the package passing through the measurement position. FIG. 5B is a schematic side view of the package opening system, which illustrates the package passing through the measurement position. In FIG. 5B, illustration of contents of the package 100 is omitted.

As illustrated in FIGS. 5A and 5B, the first and second distance measuring sensors 30 and 32 irradiate, with laser light LL, the package 100 being moved toward the opening position OP by the conveying device 20, that is, passing through the measurement position MP. The first and second distance measuring sensors 30 and 32 receive reflected light of the laser light LL reflected by the package 100. The first and second distance measuring sensors 30 and 32 calculate a distance from the package 100 on the basis of a time from the start of the irradiation with the laser light LL to the reception of the reflected light. In the present embodiment, the first and second distance measuring sensors 30 and 32 irradiate an outer surface of the first side wall 104d defining the opening 104a of the tub 104 with the laser light LL. Therefore, the first and second distance measuring sensors 30 and 32 continuously measure the distance from the package 100 until the package 100 completely passes the measurement position MP.

The calculation of the shape of the opening of the tub 104 of the package 100 based on the distances measured by the first and second distance measuring sensors 30 and 32 will be described later.

In the present embodiment, in order to fix the package 100 that has carried by the conveying device 20 and reached the opening position OP, the package opening system 10 includes a clamping device 40 that clamps the tub 104 of the package 100.

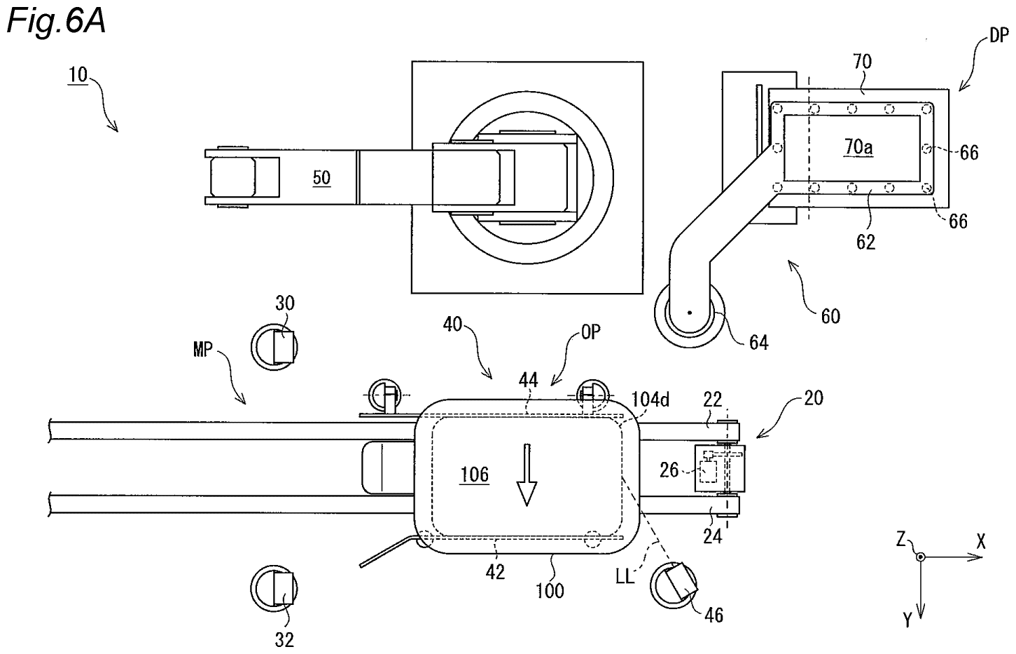

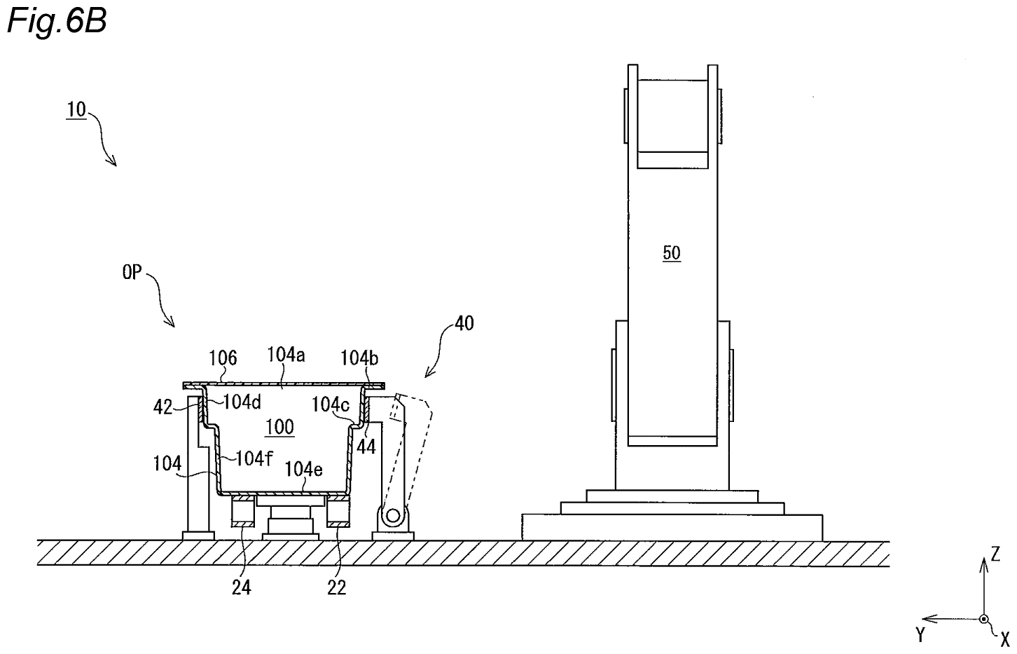

FIG. 6A is a schematic top view of the package opening system, which illustrates the package clamped by the clamping device. FIG. 6B is a schematic side view of the package opening system, which illustrates the package clamped by the clamping device. In FIG. 6B, illustration of contents of the package 100 is omitted.

As illustrated in FIGS. 6A and 6B, the clamping device 40 includes, at the opening position OP, a fixed clamp bar 42 and a movable clamp bar 44 which are arranged to face each other in a direction (Y-axis direction) orthogonal to the conveying direction (X-axis direction) of the conveying device 20.

The movable clamp bar 44 approaches or separates from the fixed clamp bar 42. Therefore, the package 100 at the opening position OP is pressed against the fixed clamp bar 42 and is sandwiched between the fixed clamp bar 42 and the movable clamp bar 44 in the width direction (s-axis direction). As a result, the package 100 is positioned in the width direction, that is, in the direction (Y-axis direction) orthogonal to the conveying direction (X-axis direction) of the conveying device 20. The fixed clamp bar 42 and the movable clamp bar 44 can also clamp the packages 100 having different sizes or having a dimensional difference between individuals in spite of the same size in design.

In the present embodiment, the fixed clamp bar 42 and the movable clamp bar 44 sandwich the first side wall 104d of the tub 104. Alternatively or additionally, the second side wall 104f may be clamped.

In order for the clamping device 40 to position the package 100 at the opening position OP, the package opening system 10 includes a third distance measuring sensor 46 for detecting the package 100 that has reached the opening position OP.

Similarly to the first and second distance measuring sensors 30 and 32 described above, the third distance measuring sensor 46 measures a distance from (the tub 104 of) the package 100. Specifically, the third distance measuring sensor 46 is arranged to irradiate, with the laser light LL, a leading surface (a leading surface in the conveying direction (X-axis direction) of the conveying device 20) of the tub 104 of the package 100 located at the opening position OP. Therefore, the third distance measuring sensor 46 can detect arrival of the package 100 at the opening position OP by measuring a predetermined distance (a distance obtained when the package 100 is located at the opening position OP). When the third distance measuring sensor 46 measures the predetermined distance, (the servomotor 26 of) the conveying device 20 stops. Therefore, the package 100 is stopped while being positioned in the length direction (t-axis direction), that is, in the conveying direction (X-axis direction) of the conveying device 20. As a result, the clamping device 40 can clamp the tub 104 of the package 100.

As illustrated in FIG. 1, the package 100 fixed at the opening position OP by the clamping device 40 is opened by cutting the lid 106 by using the cutter blade CB.

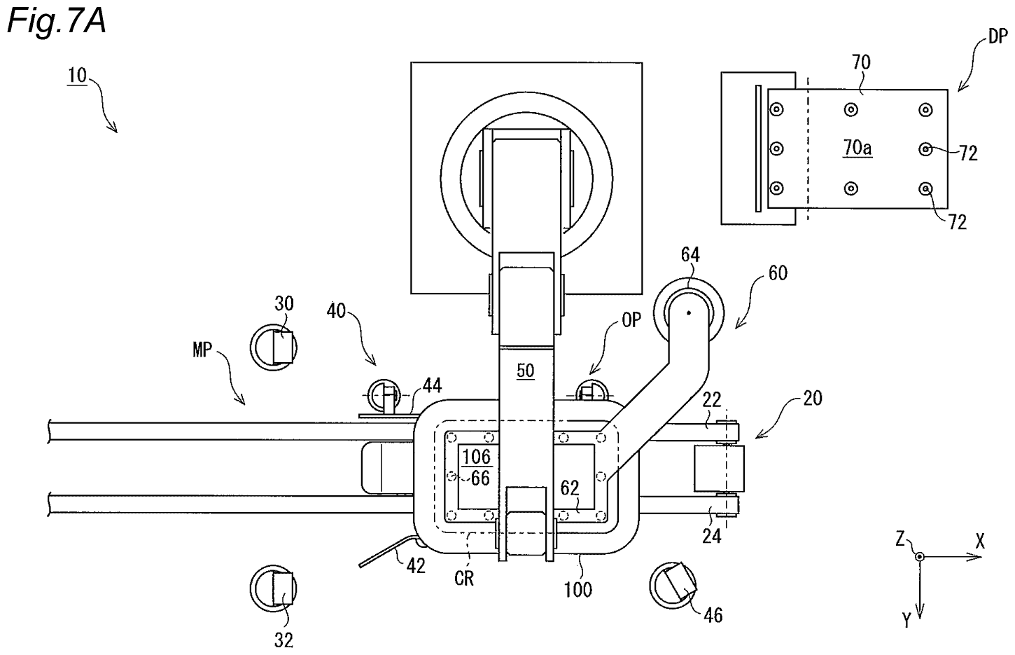

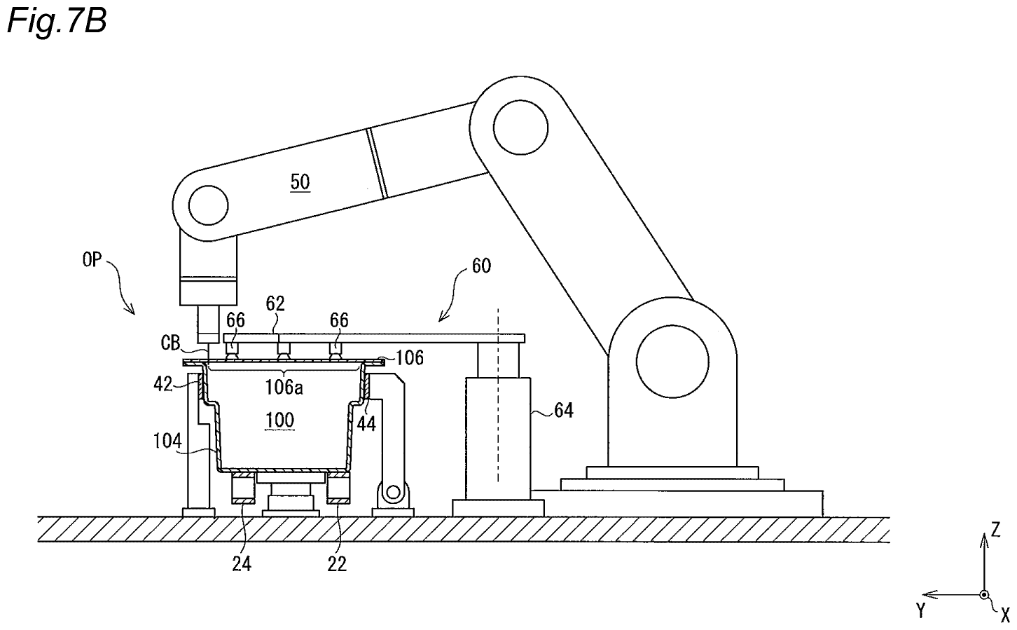

FIG. 7A is a schematic top view of the package opening system, which illustrates the package being opened by the cutter blade. FIG. 7B is a schematic side view of the package opening system, which illustrates the package being opened by the cutter blade. In FIG. 7B, illustration of contents of the package 100 is omitted.

As illustrated in FIG. 1, the package 100 is opened by moving the cutter blade CB in the cutting path CR. In order to move the cutter blade CB in the cutting path CR, the package opening system 10 includes a cutter blade moving device 50.

In the present embodiment, the cutter blade moving device 50 is an articulated robot including the cutter blade CB capable of cutting the lid 106 as an end effector. The cutter blade moving device 50 can change a spatial position (a position in the X-axis direction, the Y-axis direction, and the Z-axis direction) of the cutter blade CB and can also change a posture of the cutter blade CB.

When the cutter blade moving device 50 sticks the cutter blade CB into the lid 106 and moves the cutter blade CB stuck into the lid in the cutting path CR, a portion 106a of the lid 106 surrounded by the cutting path CR is separated from the tub 104. As a result, the package 100 is opened.

The lid 106 is held by a lid holding head (lid holding device) 62 of a lid collection device 60 while the lid 106 is being cut by the cutter blade CB.

In the present embodiment, the package opening system 10 includes the lid collection device 60 that carries the portion 106a of the lid 106 cut by the cutter blade CB and separated from the tub 104 to a disposal position DP.

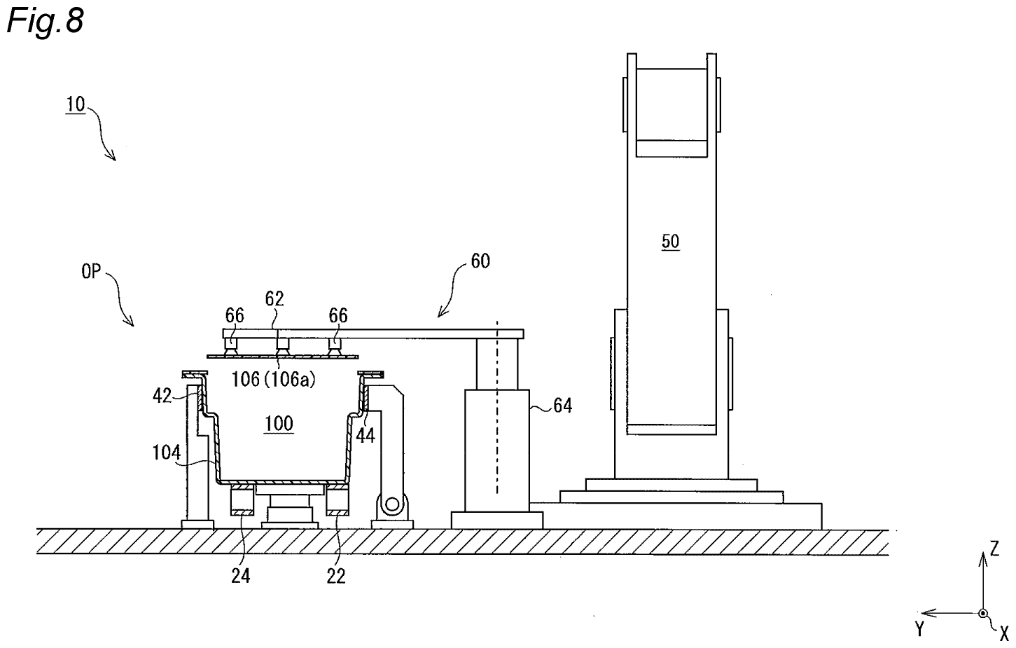

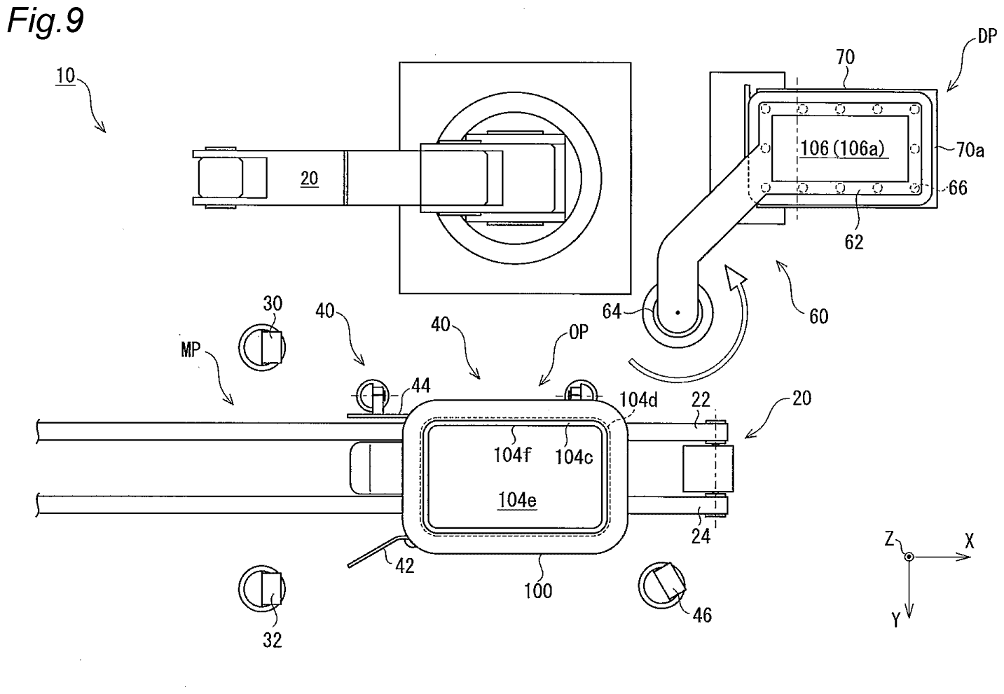

FIG. 8 is a schematic side view of the package opening system, which illustrates the lid collection device that holds the portion of the lid separated from the tub. FIG. 9 is a schematic top view of the package opening system in a state in which the portion of the lid separated from the tub is carried to the disposal position.

As illustrated in FIG. 8, the lid collection device 60 includes the lid holding head 62 that holds the lid 106 and a head moving device 64 that moves the lid holding head 62 between the opening position OP and the disposal position DP. In the present embodiment, the lid holding head 62 includes a plurality of suction nozzles 66 for sucking and holding the lid 106. The head moving device 64 is, for example, a rotary cylinder that rotates and raises and lowers the lid holding head 62.

As illustrated in FIGS. 7A and 7B, during the cutting of the lid 106 by the cutter blade CB, the lid holding head 62 of the lid collection device 60 holds the portion 106a of the lid 106 surrounded by the cutting path CR so as not to hinder the cutting of the lid 106 by the cutter blade CB. Therefore, the lid 106 is maintained in a certain posture until the cutting is completed. As a result, the cutter blade CB can move in the cutting path CR, and the package 100 can be normally opened.

The portion 106a of the lid 106 cut by the cutter blade CB and separated from the tub 104 as illustrated in FIG. 8 is carried to the disposal position DP by the lid collection device 60 as illustrated in FIG. 9. A suction table 70 to which the portion 106a of the lid 106 is sucked is arranged at the disposal position DP.

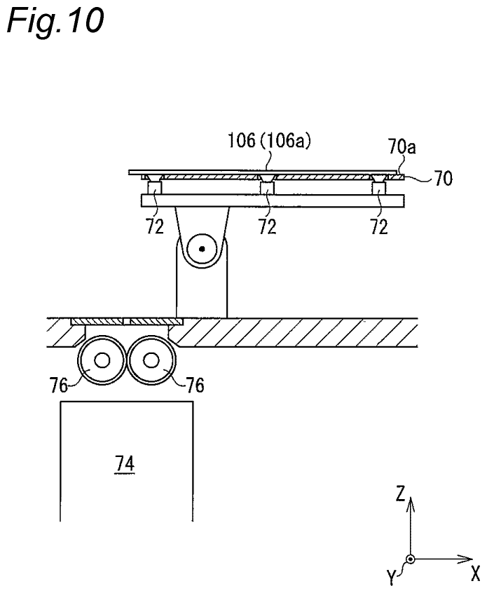

FIG. 10 is a side view of the suction table 70.

As illustrated in FIG. 10, the suction table 70 includes a placement surface 70a on which the portion 106a of the lid 106 held by the lid holding head 62 of the lid collection device 60 is placed. The suction table 70 further includes a plurality of suction nozzles 72 that sucks and holds the portion 106a of the lid 106 on the placement surface 70a. The suction table 70 is inclined to introduce the portion 106a of the lid 106 on the placement surface 70a into a disposal device 74. Specifically, when the suction table 70 is inclined, the portion 106a of the lid 106 is inserted between a pair of conveying rollers 76, and, thereafter, when the conveying rollers 76 rotate, the portion 106a of the lid 106 is drawn into the disposal device 74. As a result, the portion 106a of the lid 106 separated from the tub 104 is introduced into the disposal device 74 and is disposed of.

Instead of using the suction table 70 and the disposal device 74, the lid collection device 60 may dispose of the portion 106a of the lid 106 separated from the tub 104 in a trash can (not illustrated).

The configuration of the package opening system 10 has been described so far. Hereinafter, a control system of the package opening system 10 will be described with reference to FIG. 4.

As illustrated in FIG. 4, the package opening system 10 includes a control device 80. The control device 80 includes a conveyance control unit 82 that controls the conveying device 20, a tub opening shape calculation unit 84 that calculates the shape of the opening 104a of the tub 104 on the basis of measurement results by the first and second distance measuring sensors 30 and 32, a cutting path calculation unit 86 that calculates the cutting path CR on the basis of the calculated shape of the opening, a clamp control unit 88 that controls the clamping device 40, a lid cutting control unit 90 that controls the cutter blade moving device 50, a lid collection control unit 92 that controls the lid collection device 60, and a storage unit 94 such as a memory and a hard disk.

The control device 80 includes, for example, a CPU and a storage device such as a memory and a hard disk. The CPU operates according to programs stored in the storage device (the storage unit 94), thereby functioning as the conveyance control unit 82, the tub opening shape calculation unit 84, the cutting path calculation unit 86, the clamp control unit 88, the lid cutting control unit 90, and the lid collection control unit 92.

The conveyance control unit 82 of the control device 80 controls the conveying device 20, that is, the servomotor 26 in the present embodiment, thereby controlling conveyance of the package 10.

The tub opening shape calculation unit 84 of the control device 80 acquires (calculates) a shape of the first side wall 104d of the tub 104 on the basis of a change in distances measured by the first and second distance measuring sensors 30 and 32. The shape (contour) of the opening 104a of the tub 104 is calculated on the basis of the acquired shape of the first side wall 104d. Details of the tub opening shape calculation unit 84 will be described.

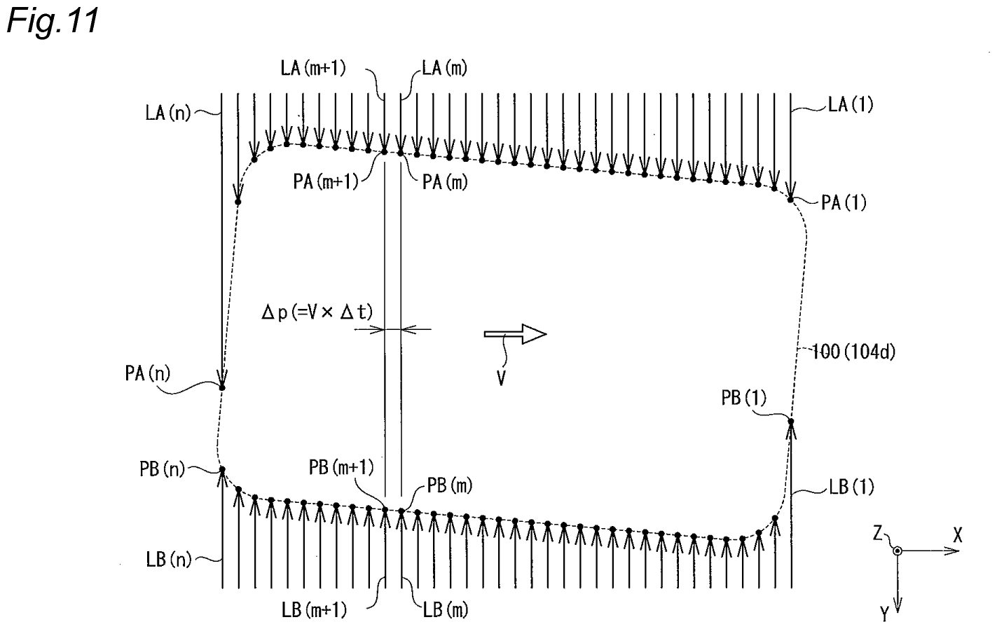

FIG. 11 is an explanatory diagram of a method of calculating the shape of the opening of the tub on the basis of the distances measured by the first and second distance measuring sensors.

As described above and as illustrated in FIGS. 5A and 5B, the first and second distance measuring sensors 30 and 32 continuously measure the distance from (the first side wall 104d of) the package 100 until the package 100 completely passes through the measurement position MP. For example, the first and second distance measuring sensors 30 and 32 continuously measure the distance from the package 100 at predetermined time intervals Δt.

As illustrated in FIG. 11, because the package 100 is carried in the conveying direction (X-axis direction) by the conveying device 20, the distance from the package (the first side wall 104d) measured by the first distance measuring sensor 30 changes. That is, the first distance measuring sensor 30 measures a plurality of distances LA(1) to LA(n) (n is an integer). Similarly, the second distance measuring sensor 32 also measures a plurality of distances LB(1) to LB(n). The numbers in parentheses indicate the order of measurement.

The tub opening shape calculation unit 84 calculates positions of a plurality of measurement points PA(1) to PA(n) and PB(1) to PB(n) on the package 100 (the first side wall 104d) at which the respective distances are measured as the plurality of distances LA(1) to LA(n) and LB(1) to LB(n). Specifically, the position of the package 100 in the direction (Y-axis direction) orthogonal to the conveying direction (X-axis direction) is calculated.

The tub opening shape calculation unit 84 calculates the position of each of the plurality of measurement points PA(1) to PA(n) and PB(1) to PB(n) in the conveying direction (X-axis direction) of the package 100 on the basis of a pitch interval Δp between the measurement points. The pitch interval Δp can be calculated by a product of a conveying speed V of the package 100 and a time interval Δt. The conveying speed V can be obtained on the basis of a rotation speed of the servomotor 26 of the conveying device 20.

Next, based on a position on a horizontal plane (X-Y plane) of each of the plurality of measurement points PA(1) to PA(n) and PB(1) to PB(n) on the first side wall 104d of the package 100, the tub opening shape calculation unit 84 calculates the shape of the first side wall 104d, that is, a contour shape on the horizontal plane.

Because the first side wall 104d defines the opening 104a of the tub 104, the tub opening shape calculation unit 84 calculates the shape of the opening 104a of the tub 104 on the basis of the shape of the first side wall 104d. For example, the shape of the opening 104a of the tub 104 is calculated by correcting the shape of the first side wall 104d in consideration of a thickness and draft of the first side wall 104d. Information regarding the thickness and draft of the first side wall 104d is stored in the storage unit 94 in advance.

Returning to FIG. 4, the cutting path calculation unit 86 of the control device 80 calculates the cutting path CR of the cutter blade CB on the basis of the shape of the opening 104a of the tub 104 calculated by the tub opening shape calculation unit 84.

Specifically, in the present embodiment, the cutting path calculation unit 86 calculates an annular cutting path CR for the cutter blade CB to move along the entire contour of the opening 104a without coming into contact with the first side wall 104d defining the opening 104a of the tub 104. For example, the cutting path CR is calculated in consideration of the draft of the first side wall 104d. The cutting path CR is calculated so that an opening of the lid 106 cut by the cutter blade CB has a size that allows the nest 108 to pass therethrough. Therefore, the cutting path CR in which the cutter blade CB moves along the contour of the opening 104a while having a distance of, for example, 1 mm from the contour is calculated.

The clamp control unit 88 of the control device 80 controls the movable clamp bar 44 of the clamping device 40 to clamp the package 100 that has reached the opening position OP as illustrated in FIGS. 6A and 6B.

The lid cutting control unit 90 of the control device 80 controls the cutter blade moving device 50 to move the cutter blade CB in the cutting path CR calculated by the cutting path calculation unit 86 as illustrated in FIGS. 7A and 7B. Therefore, the lid 106 is cut and the package 100 is opened.

The lid collection control unit 92 of the control device 80 controls the lid collection device 60 to carry the portion 106a of the lid 106 cut by the cutter blade CB and separated from the tub 104 from the opening position OP to the disposal position DP.

According to the present embodiment described above, it is possible to open the package 100 in which the outer peripheral edge of the lid 106 is bonded to the opening edge 104b of the tub 104 while preventing contamination by an adhesive.

Further, according to the present embodiment, because the cutting path CR of the cutter blade CB is calculated on the basis of the shape of the first side wall 104d defining the opening 104a of the tub 104, it is possible to open the packages 100 having different sizes or having a dimensional difference between individuals in spite of the same size in design.

According to the present embodiment, it is possible to open the package 100 while maintaining adhesion between the opening edge 104b of the tub 104 and the outer peripheral edge of the lid 106, that is, without peeling off the lid 106 from the tub 104. Therefore, the adhesive is prevented from falling off the tub 104 or the lid 106, and thus contamination by the adhesive is prevented.

Although the present disclosure has been described with reference to the above-described embodiment, the embodiment of the present disclosure is not limited thereto.

For example, in the above-described embodiment, the shape of the opening 104a of the tub 104 is calculated in order to calculate the cutting path CR of the cutter blade CB. In order to calculate the shape of the opening 104a of the tub 104, the shape of the first side wall 104d defining the opening 104a of the tub 104 is calculated as illustrated in FIG. 11. Then, in order to calculate the shape of the first side wall 104d, the distances from the first side wall 104d are continuously measured by the first and second distance measuring sensors 30 and 32. However, the embodiment of the present disclosure does not limit means for acquiring the shape of the first side wall 104d defining the opening 104a of the tub 104 to the first and second distance measuring sensors 30 and 32. For example, an image of the package 100 may be captured from below by a camera, and the shape of the first side wall 104d may be acquired on the basis of the image of the first side wall 104d appearing in the captured image.

In the above-described embodiment, the cutter blade moving device 50 that moves the cutter blade CB is an articulated robot. However, the embodiment of the present disclosure is not limited thereto. That is, any device may be used as long as the device can move the cutter blade CB in the horizontal direction and the vertical direction and rotate the cutter blade CB around a rotation center line extending in the vertical direction.

In the above-described embodiment, the cutting path CR of the cutter blade CB is annular along the entire contour of the opening 104a of the tub 104 as illustrated in FIG. 1. However, the embodiment of the present disclosure is not limited thereto. For example, the cutting path CR may be a U-shape along part of the contour of the opening 104a of the tub 104.

In the above-described embodiment, a belt conveyor is used as an example of the conveying device 20, but the present disclosure is not limited thereto. Any linear motion device may be used as long as the linear motion device can measure a moving amount of the package 100.

In the above-described embodiment, the plurality of drug containers 102 is stored in the package 100 as a stored object as illustrated in FIG. 2. However, the embodiment of the present disclosure does not limit an article stored in the package to the drug containers.

That is, a package opening system according to an embodiment of the present disclosure is, in a broader sense, a package opening system for opening a package in which an outer peripheral edge of a sheet-like lid is bonded to a flange-shaped opening edge of a tub storing a stored object includes: a cutter blade capable of cutting the lid; and a cutter blade moving device configured to stick the cutter blade into the lid and moves the cutter blade stuck into the lid in a cutting path along at least part of a contour of an opening of the tub.

### INDUSTRIAL APPLICABILITY

The present disclosure is applicable to opening of a package in which an outer peripheral edge of a sheet-like lid is bonded to a flange-shaped opening edge of a tub.

1. A package opening system for opening a package in which an outer peripheral edge of a sheet-like lid is bonded to a flange-shaped opening edge of a tub storing a stored object, the package opening system comprising:
a cutter blade capable of cutting the lid; and
a cutter blade moving device configured to stick the cutter blade into the lid and move the cutter blade stuck into the lid in a cutting path along at least part of a contour of an opening of the tub.

2. The package opening system according to claim 1, wherein
the cutter blade moving device is an articulated robot including the cutter blade as an end effector.

3. The package opening system according to claim 1, wherein:
the cutter blade moving device moves the cutter blade in an annular cutting path along an entire contour of the opening of the tub; and
the package opening system further includes a lid holding device configured to hold a portion of the lid surrounded by the annular cutting path during the cutting of the lid by the cutter blade.

4. The package opening system according to claim 3, further comprising
a disposal device for the lid, wherein
the lid holding device carries the portion of the lid toward the disposal device when the held portion of the lid is separated from the tub.

5. The package opening system according to claim 1, further comprising:
a tub opening shape calculation unit configured to acquire a shape of a side wall of the tub defining the opening and calculate a shape of the opening on the basis of the shape of the side wall; and
a cutting path calculation unit configured to calculate the cutting path on the basis of the shape of the opening calculated by the tub opening shape calculation unit.

6. The package opening system according to claim 5, further comprising:
a conveying device configured to carry the package to an opening position where the lid is cut and opened by the cutter blade; and
first and second distance measuring sensors arranged on both sides of a measurement position through which the package being moved by the conveying device toward the opening position passes and configured to continuously measure a distance from the side wall until the package completely passes through the measurement position, wherein
the tub opening shape calculation unit calculates the shape of the side wall on the basis of a change in distance measured by each of the first and second distance measuring sensors.

7. The package opening system according to claim 6, wherein:
the conveying device is a belt conveyor; and
the package opening system further includes a clamping device configured to clamp and fix the tub of the package on the belt conveyor at the opening position.

8. The package opening system according to claim 1, wherein
the stored object includes a plurality of drug containers.
